(19) United States
(12) Patent Application Publication
(10) Pub. No.: US 2010/0203967 A1
(43) Pub. Date: Aug. 12, 2010

(54) Exercising game system and method thereof

(75) Inventors: Chaucer Chiu, Taipei (TW); Guo Hua Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,845

(22) Filed: Feb. 6, 2009

(51) Int. Cl. G06F 17/00

(52) U.S. Cl. 463/32

(57) ABSTRACT

An exercising game system and the method thereof are provided. The system collects a speed parameter and a time parameter of an exerciser, and compute to obtain a distance parameter for extracting a corresponding virtual image. This solves the problems that the exerciser may cheat during the game and that the exercising process is boring. Besides, the game becomes more realistic so that the user enjoys using it.

### BACKGROUND OF THE INVENTION

1. Field of The Invention

The invention relates to an exercising game system and the method thereof. In particular, it relates to a game system that simulates multiple persons using it at the same time and the method thereof.

2. Related Art

In recent years, with rapid development in economical and industrial activities and improvements in life quality, more amusements are available to most people. Also, people pay more attention to exercising activities. However, most of the people cannot do outdoor activities. Therefore, some would buy exercising utilities to exercise at home. Alternatively, some go to gymnasiums to use their exercising bicycles or treadmills.

Since such exercising utilities are for indoor uses, the exercisers can only repeat the same actions (e.g., walking or cycling) all the time. There is no attractive goal of motivation. This may be so boring that the exercisers cannot continue for a long time and eventually quit. Moreover, there are many game machines on the market. It is found that exercisers often cheat during the games. For example, a user may not really run on a running game machine, but only let the running game machine run on its own. In such cases, exercisers may cheat and make the game unfair.

In summary, the prior art long has the problem that exercisers may cheat during exercising processes and the exercising activities are often boring. It is therefore necessary top problem a solution.

### SUMMARY OF THE INVENTION

In view of the foregoing, the invention discloses an exercising game system and the method thereof.

The disclosed exercising game system includes at least one exercising user and an exercising server. The exercising server establishes network connections with various exercising users. Each of the exercising users includes a weight determining module, a collecting module, a transmitting module, and a displaying module. The weight determining module uses a weight detector to determine whether the weight of an exerciser is greater than a predetermined value. The collecting module uses a sensor to collect a speed parameter and a time parameter of the exerciser when the weight of the exerciser is determined to be greater than the predetermined value. The transmitting module transmits the speed parameter and the time parameter. The exercising server includes a receiving module, a computing module, and a simulating module. The receiving module receives the speed parameter and the time parameter from each of the exercising users. The computing module uses each of the speed parameter and the time parameter to compute a corresponding distance parameter for the corresponding exercising user. The simulating module extracts a virtual image for each of the exercising users according to the corresponding distance parameter and transmits it the corresponding exercising user for its displaying modules to display.

The disclosed exercising game method includes the steps of: connecting at least one exercising user with an exercising server through a network; using a weight detector to determine whether the weight of an exerciser is greater than a predetermined value at each of the exercising users; collecting a speed parameter and a time parameter of the exerciser of each of the exercising users when the weight of the exerciser is determined to be greater than the predetermined value; transmitting the speed parameter and the time parameter from each of the exercising users to the exercising server; using the speed parameter and the time parameter of each of the exercising users to compute a corresponding distance parameter by the exercising server; extracting a virtual image for each of the exercising users according to the corresponding distance parameter by the exercising server and transmitting it to the corresponding exercising user for display.

According to the above description the invention differs from the prior art in that the invention collects the speed parameter and the time parameter of an exerciser, and computes the distance parameter accordingly, and extracts the corresponding virtual image.

Through the disclosed techniques, the invention can prevent exercisers from cheating as well as achieve realistic effects so that the exercisers can enjoy exercising.

### BRIEF DESCRIPTION OF THE DRAWINGS

The invention will become more fully understood from the detailed description given herein below illustration only, and thus is not limitative of the present invention, and wherein:

FIG. 1 is a structural diagram of the disclosed exercising game system;

FIG. 2 is a detailed block diagram of the disclosed exercising game system;

FIG. 3 is a flowchart of the disclosed exercising game method; and

FIGS. 4 to 8 are schematic views of an embodiment of the disclosed exercising game system.

### DETAILED DESCRIPTION OF THE INVENTION

The present invention will be apparent from the following detailed description, which proceeds with reference to the accompanying drawings, wherein the same references relate to the same elements.

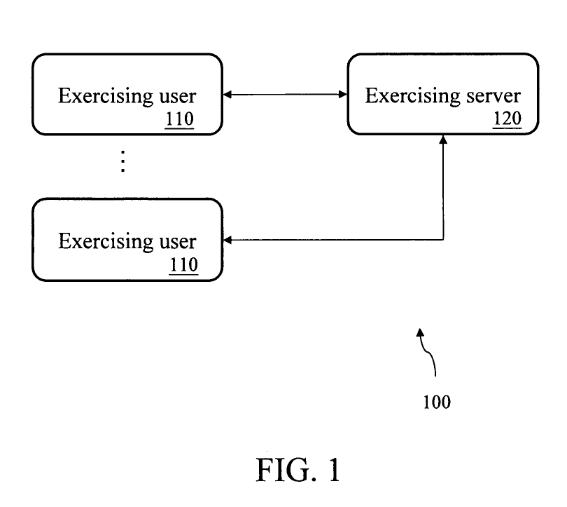

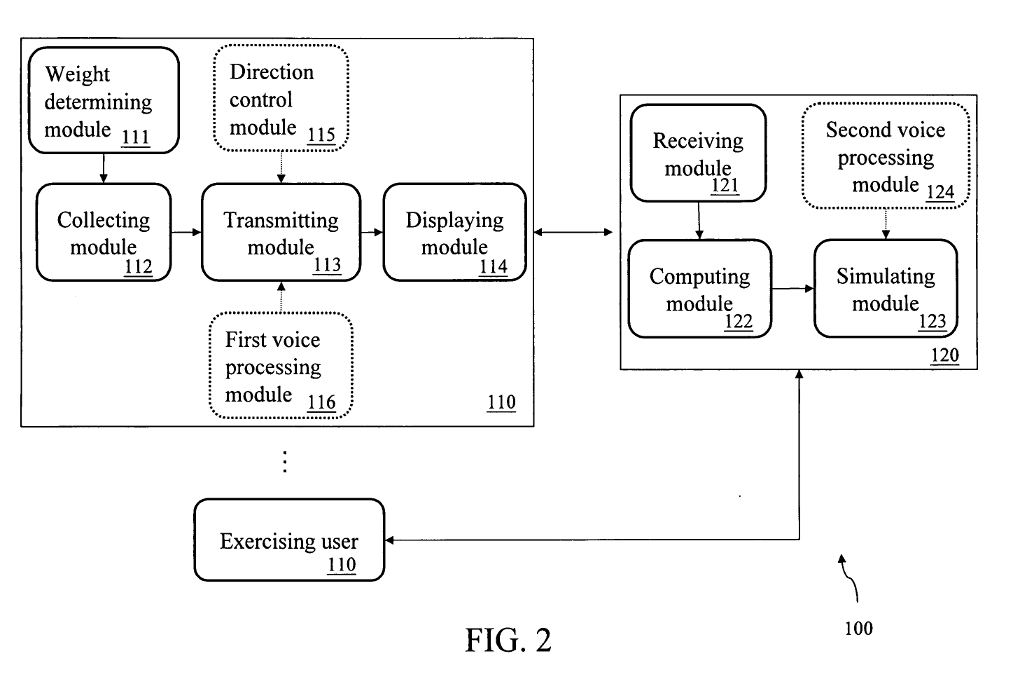

Before describing the embodiments of the invention, we refer to FIGS. 1 and 2 for an explanation of the disclosed exercising game system and method. FIG. 1 is the structural diagram of the disclosed exercising game system and FIG. 2 is the detailed block diagram. The exercising game system 100 includes: at least one exercising user 110 and an exercising server 120. Each of the exercising users 110 includes a weight determining module 111, a collecting module 112, a transmitting module 113, and a displaying module 114. The exercising server 120 includes a receiving module 121, a computing module 122, and a simulating module 123.

With reference to FIG. 1, the exercising user 110 is an exercising device for an exerciser to play an exercising game. The exercising user 110 can be an exercising treadmill or bicycle for the exerciser to play the game.

The exercising server 120 establishes network connections with individual exercising users 110. That is, each of the exercising users 110 is an exercising device with the Internet connection ability to connect to the exercising server 120 through the Internet. Alternatively, each of the exercising users 110 can be an exercising device with the local area networking ability to connect to the exercising server 120 through the local area network (LAN). It should be noted that the exercising server is the server of the exercising game. It provides services to the exercising users 110 through network connections.

If two exercising users 110 connect to the exercising server 120 through network connections for playing the exercising game, they can opt to play the game together and make it a competition or not.

Please refer to FIG. 2. Each of the exercising users 110 includes a weight determining module 111, a collecting module 112, a transmitting module 113, and a displaying module 114. The weight determining module 111 uses a weight detector to determine whether the weight is greater than a predetermined value. The weight detector uses the weight of the exerciser to determine whether he is really using the exercising device. The predetermined value can be, for example, 35 kg. This predetermined value can be preset by the system. For example, suppose the exercising user 110 is a treadmill, the exerciser's weight is 50 kg and the predetermined value is set as 35 kg in this case, when the exerciser stands on the exercising user 110, the weight detector detects 50 kg and the weight determining module 111 of the exercising user 110 determines that it is greater than 35 kg. The purpose of the weight determining module 111 is to prevent the exerciser from cheating in the game. This is because when the exerciser does not correctly use the exercising user 110 to play the game, the collected parameters become meaningless.

The collecting module 112 uses a sensor to collect a speed parameter and a time parameter of the exerciser when the weight determining module 111 determines that the detected weight is greater than the predetermined value. The sensor detects the speed of motion elements of the exercising user 110, such as motor, transmitting element, roller, or belt. That is, when the weight determining module 111 determines that the weight is greater than the predetermined value, the collecting module 112 uses the speed detected by the sensor as the speed parameter of the exerciser during the exercise. For example, the speed parameter is ‘15 km/h’. It further records time for the time parameter. For example, the time parameter is ‘2008-10-12 16:30:15’.

The transmitting module 113 transmits the speed parameter and the time parameter collected by the collecting module 112 to the exercising server 120. Since the exercising user 110 is an exercising device with the Internet function, it can establish a network connection with the exercising server 120. The transmitting module 113 of the exercising user 110 can transmit the speed parameter and the time parameter to the exercising server 120 through the network connection.

The displaying module 114 displays the virtual image transmitted from the exercising server 120. That is, the exercising user 110 receives the virtual image transmitted from the exercising server 120 and displays it. The virtual image will be detailed later.

The exercising server 120 includes a receiving module 121, a computing module 122, and a simulating module 123. After the exercising server 120 establishes network connections with the exercising users 110, its receiving module 121 receives the speed parameter and the time parameter of all of the exercising users 110. In other words, the receiving module 121 simultaneously receives the speed parameter and the time parameter from all different exercising users 110.

The computing module 122 uses the speed parameter and the time parameter of each exercising user 110 to compute a corresponding distance parameter. The distance parameter is computed using the relation: ‘distance=speed*time’. It gives the distance advanced by each exercising user 110 after some interval. In other words, the computing module 122 takes the speed parameter and the time parameter of different exercising users 110 and computes the corresponding distance parameter. For example, suppose the time parameter and the speed parameter of the exercising users 110 are collected every 10 seconds, the computing module 122 follows the relation ‘distance=speed*time’ to obtain the distance advanced by each of the exercising user 110 in 10 seconds. It further sums up the distance to obtain a total distance, which is another distance parameter.

The simulating module 123 extracts a virtual image corresponding to the distance parameter of each of the exercising users 110, and transmits it to the corresponding exercising user 110. The displaying module 114 of the exercising user 110 then displays the virtual image. That is, the simulating module 123 extracts the virtual image according to the distance parameter of exercising user 110 computed by the computing module 122. The virtual image of the exercising user 110 is then sent via the network connection to the exercising user 110. Finally, the displaying module 114 of each of the exercising users 110 displays the corresponding virtual image.

It should be noted that the virtual image of the exercising user 110 extracted by the simulating module 123 includes the virtual characters that simulate all of the exercising users 110. That is, the virtual image has virtual characters representing all of the exercising users 110 and simulating their conditions. It is worth mentioning that when the distance parameters of at least two exercising users 110 fall within the same range of the virtual image, the virtual characters of them are concurrently shown in the corresponding exercising users. That is, if the distance parameters of two or more exercising users 110 fall within the same range of the virtual image, the simulating module 123 of the exercising server 120 renders the same virtual image. In the end, the virtual characters represented by the corresponding exercising users 110 are concurrently displayed in the same virtual image.

It should be noted that each of the exercising users 110 can further have a direction control module 115 responsible for generating a direction parameter. The direction parameter is transmitted via the transmitting module 113 to the exercising server 120. The exercising server 120 uses the direction parameter to extract the corresponding virtual image.

Moreover, each of the exercising users 110 can further have a first voice processing module 116. The exercising server 120 further has a second voice processing module 124. The first voice processing module 116 receives and transmits voice information. The second voice processing module 124 receives voice information transmitted from all of the exercising users 110 and transmits such voice information to other exercising users 110. That is, the first voice processing module 116 receives the voice information made by the exerciser at an exercising user 110, and transmits it to the exercising user server 120. After the second voice processing module 124 of the exercising server 120 receives the voice information transmitted from all of the exercising users 110. It further transmits the voice information to other exercising users 110. The voice processing modules 116 of the other exercising users 110 receive the voice information transmitted from the exercising server 120. Therefore, the exercisers use the first voice processing module 116 of the exercising users 110 and the second voice processing module of the exercising server 120 to achieve voice communications with others.

The above-mentioned exercising game system collects the speed parameter and the time parameter of the exercisers, computes their distance parameters, and extracts the corresponding virtual images. It prevents the exercisers from cheating and makes the game more interesting.

The following paragraphs use an explicit example to explain the invention. However, this embodiment should not be used to limit the scope of the invention. Any person skilled in the art can make obvious modifications without departing from the spirit of the invention.

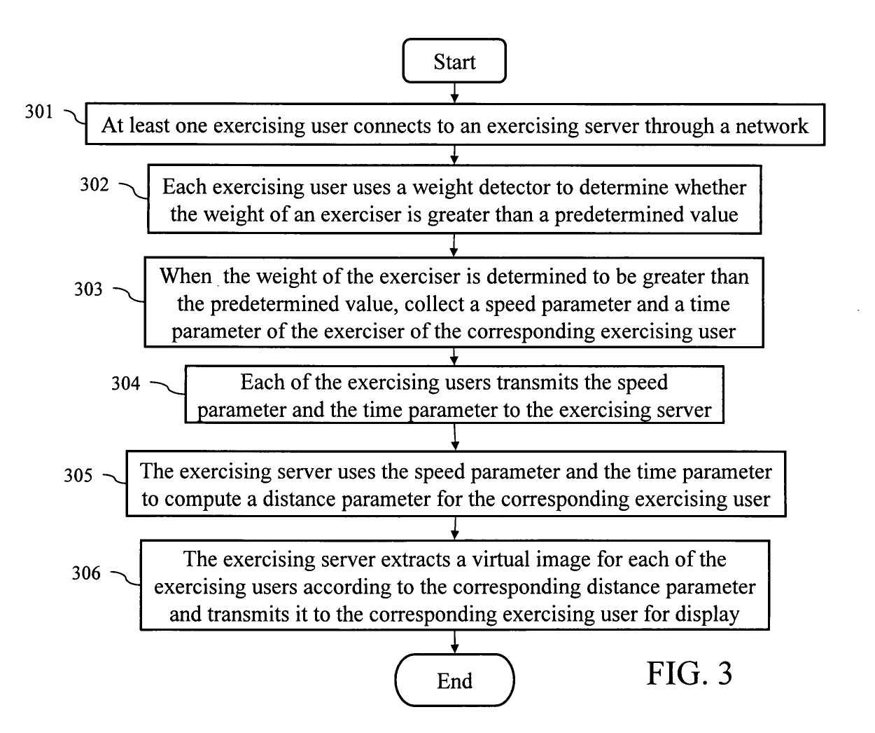

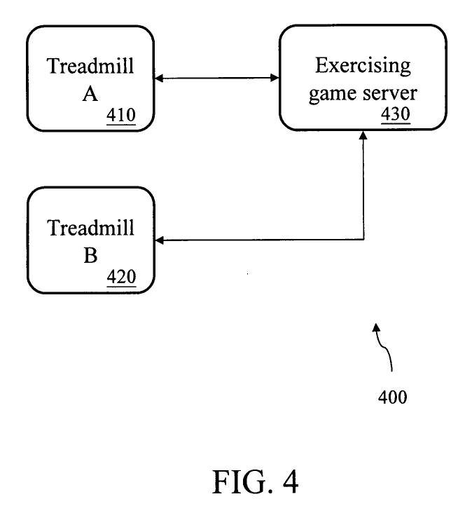

FIG. 3 is a flowchart of the disclosed exercising game method. FIGS. 4 to 8 are schematic views of an embodiment of the disclosed system. The following description details steps of the invention with simultaneous reference to FIGS. 3 to 8.

Please refer to FIG. 4. The exercising game system 400 includes a treadmill A 410 (i.e., an exercising user), a treadmill B 420(i.e., another exercising user), and an exercising game server 430 (i.e., the exercising server). An exerciser A uses the treadmill A 410 to run. An exerciser B uses the treadmill B 420 to run. The treadmill A 410 and the treadmill B 420 establish connections with the exercising game server 430 through a network (step 301). In other words, the treadmill A 410 and the treadmill B 420 establish network connections with the exercising game server 430 for online the exercising game. The operation of the exercising game server 430 enables the treadmill A 410 and the treadmill B 420 to form a competition in the exercising game.

The treadmill A 410 has a weight detector to determine whether the exerciser A is correctly using the treadmill 410 for the game. The treadmill A 410 uses the weight detector to determine whether the weight of exerciser A is greater than a predetermined value ‘35 kg’ when using the treadmill A 410 (step 302). The predetermined value ‘35 kg’ is predetermined by the treadmill A 410. Likewise, the treadmill B 420 also uses a weight detector to determine whether the weight of exerciser B is greater than the predetermined value ‘35 kg’ when using the treadmill B 420. Of course, the predetermined value ‘35 kg’ is predetermined by the treadmill B 420.

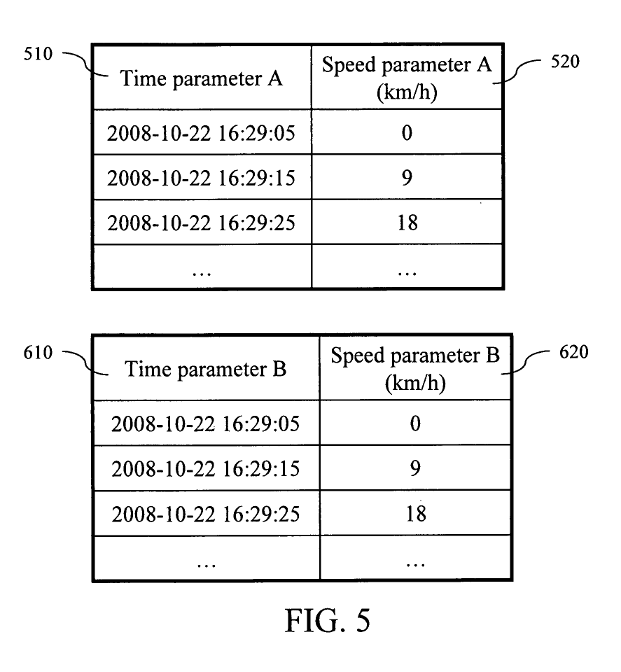

Please refer to FIG. 5. Suppose the exercise A is correctly using the treadmill A 410 and his weight is 50 kg. Therefore, the weight detector of the treadmill A 410 determines that the exerciser A has a weight ‘50 kg’ greater than the predetermined value ‘35 kg’ when using the treadmill A 410. In this case, the treadmill A 410 collects the speed parameter A 520 of the exerciser A (e.g., ‘9 km/h’) and the time parameter A 510 (e.g., ‘2008-10-22 16:29:15’). At the same time, suppose the exerciser B has a weight of 60 kg. The weight detector of the treadmill B 420 determines that the exerciser B has a weight ‘60 kg’ greater than the predetermined value ‘35 kg’ when using the treadmill B 420. In this case, the treadmill B 420 collects the speed parameter B 620 (e.g., ‘9 km/h’) and the time parameter B 610 (e.g., ‘2008-10-22 16:29:15’) of the exerciser B (step 303).

After the treadmill A 410 collects the speed parameter A 520 and time parameter A 510, the treadmill A 410 transmits them to the exercising game server 430 via the network connection. After the treadmill B 420 collects the speed parameter B 620 and time parameter B 610, the treadmill A 410 transmits them to the exercising game server 430 via the network connection (step 304).

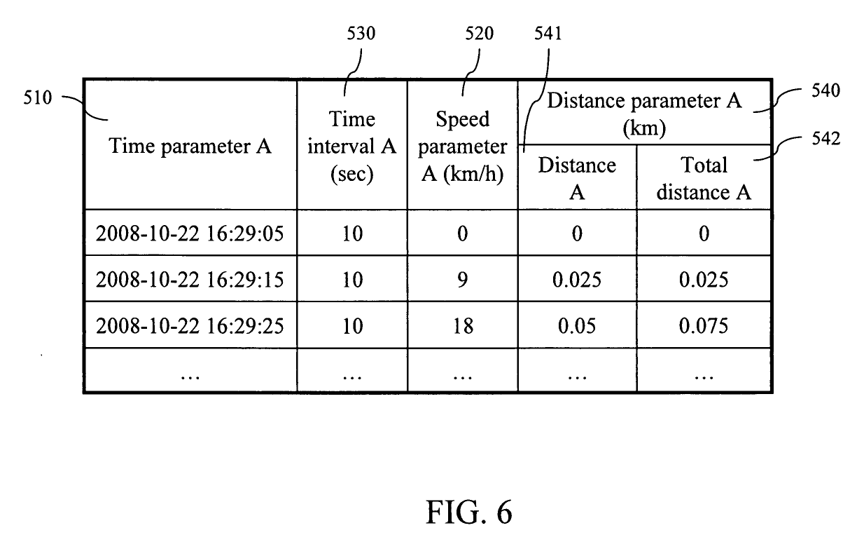

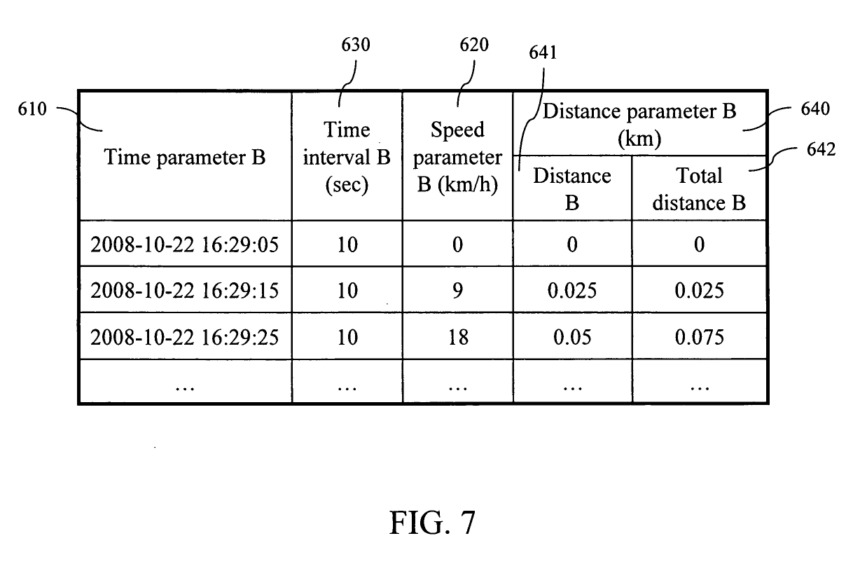

Please refer to FIGS. 6 and 7. The exercising game server 430 uses the time parameter A 510 and the speed parameter A 520 for computation. Since the time interval A 530 obtained between time parameters A 510 is 10 sec, the distance parameter A 540 in the 10 sec is obtained using the relation ‘distance=speed*time’. For example, the distance parameter A 541 of the time parameter A 510 ‘2008-10-22 16:29:25’ is 0.05 km. The distance is then accumulated to obtain the total distance A 542, e.g., 0.075 km. At the same time, the exercising game server 430 also uses the time parameter B 610 and the speed parameter B 620 for computation. Since the time interval 630 of the time parameter B 610 is 10 sec, the relation ‘distance=speed*time’ gives the distance parameter B 640 in each 10 sec. For example, the distance B 641 of the time parameter B 610 ‘2008-10-22 16:29:25’ is 0.05 km. The distance is then accumulated to obtain the total distance B 642, e.g., 0.075 km (step 305).

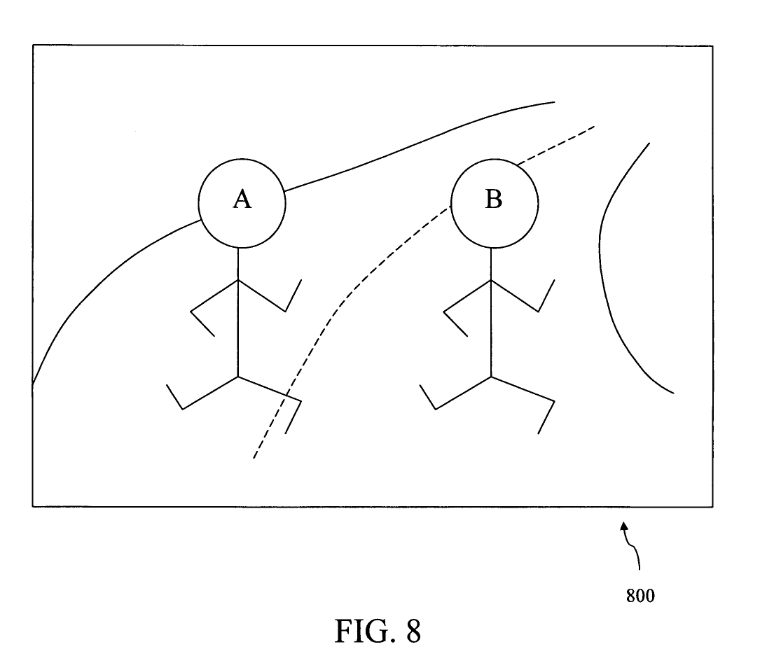

After the exercising game server 430 obtains the total distance A 542 of the treadmill A 410 and the total distance B 642 of the treadmill B 420, the exercising game server 430 extracts virtual image A and virtual image B according to the total distance A 542 (e.g., 0.075 km) and the total distance B 642 (e.g., 0.075 km). The total distance A 542 ‘0.075 km’ and the total distance B 642 ‘0.075 km’ fall in the same virtual image. It should be noted that if different exercisers start their games at different times, the exercising game server 430 extracts the corresponding virtual images of the distances. If the distances are different, the exercising game server 430 obtains different virtual images. Therefore, according to the total distance A 542 ‘0.075 km’ and the total distance B 642 ‘0.075 km’, the extracted virtual image A and the virtual image B are the same. In the virtual image A, there is a virtual character A simulating the exerciser A. In the virtual image B, there is a virtual character B simulating the exerciser B. Since the virtual image A and the virtual image B are the same, both the virtual character A and the virtual character B appear in the same virtual image. That is, in addition to the virtual character A, the virtual image A also has the virtual character B. In addition to the virtual character B, the virtual image B also has the virtual character A. After obtaining the virtual image A and the virtual image B, the exercising game server 430 transmits the virtual image A to the treadmill A 410 for display, and transmits the virtual image B to the treadmill A 420 for display. The displayed results are shown in the virtual image display interface 800 in FIG. 8 (step 306).

In summary, the invention differs from the prior art in that it collects the speed parameter and the time parameter of the exercisers. Through some calculations, it obtains the distance parameters and extracts the corresponding virtual images. The disclosed techniques can prevent exercisers from cheating in the exercising game and make the exercising process interesting. Therefore, the invention achieves the goals of no cheating and realistic effects, making the exercises enjoyable.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An exercising game system, comprising:
at least one exercising user, each of which includes:
a weight determining module, which uses a weight detector to determine whether the weight of an exerciser is greater than a predetermined value;
a collecting module, which uses a sensor to collect a speed parameter and a time parameter of the exerciser when the weight of the exerciser is determined to be greater than the predetermined value;
a transmitting module, which transmits the speed parameter and the time parameter; and
a display module; and
an exercising sever, which establishes network connections with the exercising users and includes:
a receiving module, which receives the speed parameter and the time parameter transmitted from each of the exercising users;
a computing module, which uses each of the speed parameter and the time parameter to compute a corresponding distance parameter for the corresponding exercising user; and
a simulating module, which extracts a virtual image for each of the exercising users according to the corresponding distance parameter and transmits the virtual image to the corresponding exercising user for its displaying module to display.

2. The exercising game system of claim 1, wherein the virtual image includes a virtual character that simulates the exerciser.

3. The exercising game system of claim 1, wherein the virtual character of each of the exercising users is simultaneously displayed on a same virtual image when more than one exercising users have distance parameters falling within the same virtual image range.

4. The exercising game system of claim 1, wherein each of the exercising users further includes a direction control module to generate a direction parameter and transmit it to the exercising server so that the exercising server extracts the virtual image according to the direction parameter.

5. The exercising game system of claim 1, wherein the exercising users include exercising treadmills or exercising bicycles.

6. The exercising game system of claim 1, wherein each of the exercising users further includes a first voice processing module for receiving and transmitting voice information and a second voice processing module for receiving the voice information transmitted from the exercising users and transmitting it to the other exercising users.

7. An exercising game method, comprising the steps of:
connecting at least one exercising user with an exercising server through a network;
using a weight detector to determine whether the weight of an exerciser is greater than a predetermined value at each of the exercising users;
collecting a speed parameter and a time parameter of the exerciser of each of the exercising users when the weight of the exerciser is determined to be greater than the predetermined value;
transmitting the speed parameter and the time parameter from each of the exercising users to the exercising server;
using the speed parameter and the time parameter of each of the exercising users to compute a corresponding distance parameter by the exercising server; and
extracting a virtual image for each of the exercising users according to the corresponding distance parameter by the exercising server and transmitting it to the corresponding exercising user for display.

8. The exercising game method of claim 7, wherein the virtual image includes a virtual character that simulates the exerciser.

9. The exercising game method of claim 7, wherein the virtual character of each of the exercising users is simultaneously displayed on a same virtual image when more than one exercising users have distance parameters falling within the same virtual image range.

10. The exercising game method of claim 7 further comprising the step of generating a direction parameter and transmitting it to the exercising server for it to extract the virtual image according to the direction parameter.

11. The exercising game method of claim 7, wherein the exercising users include exercising treadmills or exercising bicycles.

12. The exercising game method of claim 7 further comprising the step for each of the exercising users to receive voice information and transmit the voice information to the exercising server and for the exercising server to transmit the voice information to the other exercising users.
